(19) United States
(12) Patent Application Publication
(10) Pub. No.: US 2024/0372279 A1
(43) Pub. Date: Nov. 7, 2024

(54) Housing Part for a Hybrid Connector

(71) Applicant: TE Connectivity Solutions GmbH, Schaffhausen (CH)

(72) Inventors: Markus GIMBEL, Bensheim (DE); Ronald WIENZIERS, Bensheim (DE); Joachim SCHNEIDER, Bensheim (DE)

(73) Assignee: TE Connectivity Solutions GmbH, Schaffhausen (CH)

(21) Appl. No.: 18/652,916

(22) Filed: May 2, 2024

(30) Foreign Application Priority Data
May 4, 2023 (DE) 102023111650.9
Dec. 13, 2023 (EP) 23216358.4

(51) Int. Cl. H01R 13/00; H01R 13/514; H01R 13/52

(52) U.S. Cl. CPC H01R 13/005; H01R 13/514; H01R 13/5202

(57) ABSTRACT

Shown is a housing part for a hybrid connector for the transmission of electrical current and at least one fluid to a mating connector along a connection direction, comprising an electrical connection area and a fluid connection area which is separate from the electrical connection area and comprises an external connection located at a distal end with at least one fluid channel for connecting at least one fluid hose transversely to the connection direction.

This application claims priority to and the benefit of German Patent Application No. 102023111650.9 filed May 4, 2023 and European Patent Application No. 23216358.4 filed on Dec. 13, 2023, both of which are hereby incorporated by reference in their entirety.

The invention relates to a housing part for a hybrid connector for transmitting electric current and at least one fluid, in particular one fluid or several fluids, to a mating connector along a connection direction.

Such connectors are known and often comprise an electrical connection area and a fluid connection area separate from the electrical connection area.

It is the objective of the invention to provide a hybrid connector which can be used in areas in which the versions known to date cannot be implemented or can only be implemented poorly.

According to the invention, this is achieved by an external connection of at least one fluid channel, in particular one fluid channel or several fluid channels, the external connection being located at a distal end and configured for connecting at least one fluid hose transversely to the connection direction.

This solution has the advantage that the at least one connected fluid hose automatically protrudes laterally from the connection direction and the arc thus formed by the at least one fluid hose guarantees mobility of the hybrid connector relative to another element along the connection direction. As a result, such a hybrid connector enables the transmission of the at least one fluid between elements at variable distances, for example the transmission of cleaning water for a camera or a mirror from a vehicle body to a vehicle door and/or air.

The solution according to the invention can be further improved with the following further developments and configurations, each of which is individually preferred and can be combined with one another as desired.

In a preferred configuration, the housing part is configured such that the electrical connection area is sealed in a fluid-tight manner when connected. The term “fluid” generally refers to a gas or a liquid. In particular, tightness against liquids is important in order to prevent a short circuit. The electrical connection area can be sealed in a liquid-tight manner towards the outside and/or towards the fluid connection area.

In order to enable good sealing and/or shielding, a collar can surround a contact field of the hybrid connector. In this case, a connection of the fluid connection area can be located outside the contact field.

A configuration enabling the at least one fluid hose to be connected transversely to the connection direction may consist of an axis of a substantially tubular external connection extending in the intended direction transversely to the connection direction. The external connection can be open in the intended direction and closed in other directions.

In a preferred configuration, the external connection for connecting the at least one fluid hose is configured to be perpendicular to the connection direction. In this case, a particularly high degree of flexibility can be achieved.

In a configuration that allows simple production using an injection molding method, the at least one fluid channel comprises two respective segments with cylindrical inner shapes. Such a configuration allows simple demolding in particular. In this context, the segments can run transversely to each other and form an angle. In particular, “cylindrical” here generally means a shape with a cross-section that remains constant along one direction, wherein the cross-section does not necessarily have to be circular or elliptical, but can also have other shapes, such as partially or completely polygonal or any other shape.

The course of the at least one fluid channel can be such that there are only two straight sections in each case. Each of the sections can comprise one of the segments with a cylindrical inner shape. One of the sections can run along the connection direction. The other section can run transversely to the connection direction. There may be a corner between the two sections where the two sections converge.

In an alternative configuration, at least one fluid channel, in particular one or more fluid channels, can have a curved section, at least in sections. The section can be configured as a curve or an arc with a constant or changing radius of curvature.

Preferably, at least one fluid channel has a constant cross-section or at least a cross-sectional area remaining the same size. This minimizes the occurrence of pressure differences.

In an alternative configuration, the cross-section, in particular the cross-sectional area, can change. For example, the cross-section can widen outwards so that the at least one fluid channel has a conical inner shape. This can be used, for example, to change the pressure of the respective fluid. For example, it may be desirable for the pressure to increase due to the geometry of the fluid channel in order to be able to apply the fluid at a higher pressure. In a configuration with two cylindrical inner shapes, these can have different cross-sectional areas.

Simple manufacture is possible if the at least one fluid channel, preferably one or more fluid channels, is integral with the rest of the housing part.

In an alternative configuration, however, at least one fluid channel, in particular one or more fluid channels, can also be a separate part that is connected to the rest of the housing part. In particular, in a preferred configuration, at least one or more fluid channels can be decoupled and configured as a separate part. This can be preferred, for example, if the at least one fluid channel is made of a different material or has a shape that is difficult to manufacture.

In this configuration, the separate part can have latching elements at the proximal end, which latch with projections in the housing part, in particular in the collar, against the plug-in direction.

For a simple connection with a mating connector, an internal connection located at a proximal end can be configured for connection parallel to the connection direction.

The directions at the internal connection and the external connection can be transverse to each other, in particular at 90 degrees to each other.

In order to increase the reliability of the sealing effect, a separate seal can surround the internal connection.

For tolerance compensation, the inner clear cross-section of the at least one fluid channel can widen in an end section towards the proximal end. Alternatively, such a configuration can be used for a secure connection with an externally cone-shaped mating element. The outer cross-section can remain the same.

A further configuration can also provide for the inner clear cross-section of at least one or more fluid channels to taper in order to enable a connection with a complementary mating element of the mating connector.

The mating connector can also be configured such that it has coupling elements in the plug-in direction in order to be connected to a coupling. This enables simple expansion of the at least one fluid channel and modular use of the hybrid connector.

In order to enable the attachment of a grommet that protectively surrounds the cables and the at least one fluid hose, the housing part may have a grommet attachment portion for attaching a grommet. The grommet can accommodate electrical cables and the at least one fluid hose. It can have a hose or tube shape, but be made of a flexible material, such as rubber or silicone. It can have at least one bellows to increase flexibility.

The grommet attachment portion may be configured such that the end of the grommet attached to the connector extends transversely away from the connector, in particular perpendicular to the connection direction. In particular, it may be configured such that the grommet extends away from the connector along a direction that is parallel to a direction along which the at least one fluid hose and/or the electrical cables extend away from the connector.

A connector according to the invention comprising a housing part according to the invention may furthermore comprise further elements, in particular electrical contact elements and/or sealing elements.

In order to enable a secure connection, the connector can have a slide for securing the connector to the mating connector.

Alternatively or additionally, the connector may have a lever mechanism that secures the connection and/or increases a connection force. The lever can be configured such that it pushes a securing element into the housing part in order to secure the hybrid connector in the mating position.

The housing part and/or the connector can be configured such that, in the intended operating state, the fluid connection area is completely below the electrical connection area with respect to gravity. The intended operating state can be understood as an attached state in particular. In this case, the hybrid connector is, for example, connected to a suitable mating connector and attached to the vehicle body, wherein the vehicle is in a usual horizontal position. This can prevent the at least one fluid from entering the electrical connection area and causing a short circuit or other damage when the connector is connected or disconnected.

This can be achieved, for example, by the fluid connection area lying completely in a first half-space defined by a plane and the electrical connection area lying completely in a second half-space complementary to the first half-space. The second half-space, which is again defined by the plane, is preferably disjoint from the first half-space, i.e. the two half-spaces do not have a common spatial area. In the intended operating state, the plane then runs perpendicularly to the direction of gravity and parallel to a tangential plane of the spherical surface of the earth.

In a preferred configuration, the plane is parallel to the connection direction.

In particular, the connector can be configured as a plug. The connector can have plug elements or socket elements for the current and/or at least one fluid. In this case, the connection direction can be a plug-in direction.

According to a preferred configuration, a seal for sealing the fluid connection area is in one piece with a seal for sealing the electrical connection area. This can minimize the manufacturing effort. The seal for sealing the fluid connection area and the seal for sealing the electrical connection area can be parts and/or sections of a single seal. In order to increase operational safety, the connector can be configured such that the connection of the internal connection to a mating element is sealed off from the electrical connection area in the connected state by at least two independent seals or sealing systems. Seals can in particular comprise flexible and/or compressible materials, such as rubber or silicone. A seal can also be an O-ring, for example.

For use in the automotive sector, especially for use on a sheet metal, it is preferred if the connector is configured such that it can be connected to a mating connector attached to a surface, preferably a flat surface. The surface can be considered to be the surface of the sheet metal, for example. Parts of the connector and/or the mating connector can protrude through a hole in the surface, such as contact elements, at least in the connected state. The mating connector can have latching elements for connection to the sheet metal in order to prevent the mating connector from being pulled out in the plug-in direction.

In such a configuration, the external connection of the at least one fluid channel located at the distal end can be configured to connect the at least one fluid hose parallel to the surface.

Preferably, the connection direction for such a connector is perpendicular to the surface.

In the following, the invention is explained in more detail by means of preferred configurations with reference to the drawings. The preferred further developments and configurations shown here are each independent of one another and can be combined with one another as desired, depending on how this is necessary in the application.

It is shown by:

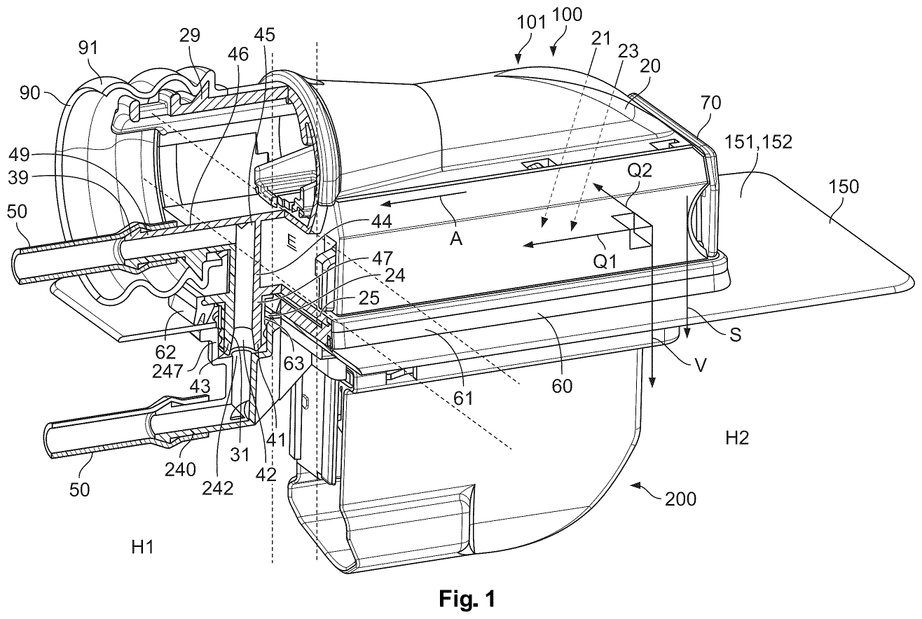

FIG. 1 a schematic, partially sectioned perspective view of an embodiment of a hybrid connector together with a mating connector;

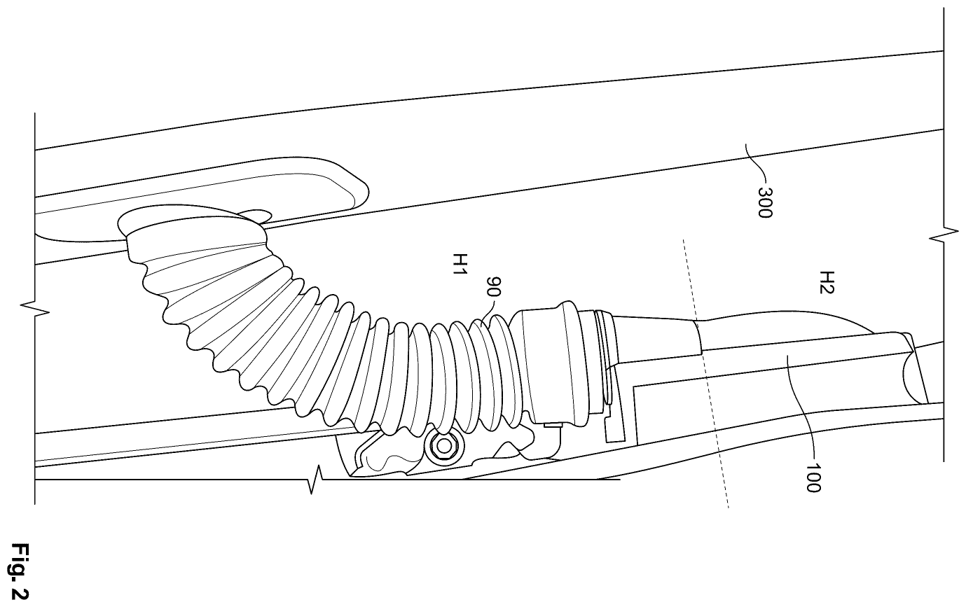

FIG. 2 a schematic perspective view of a hybrid connector in the attached state;

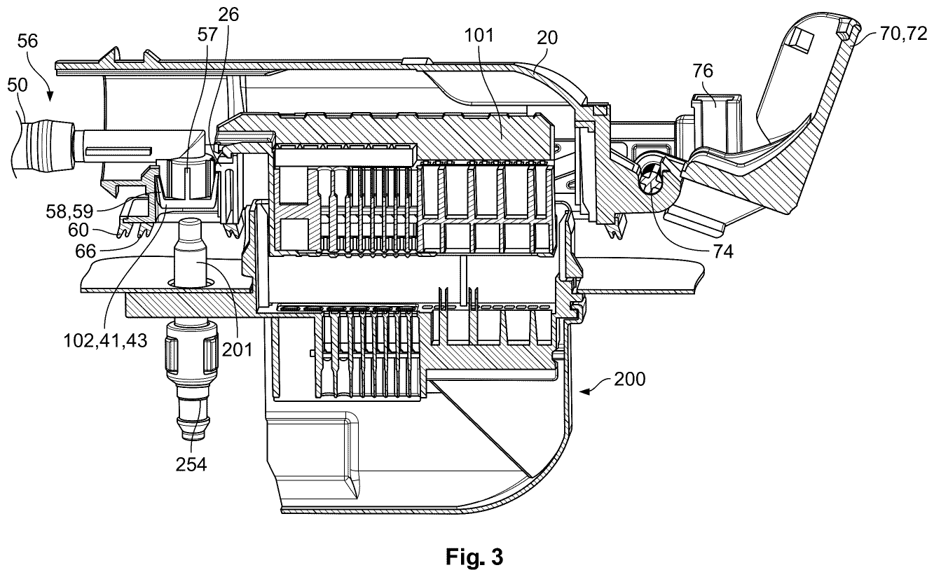

FIG. 3 a schematic, partially sectioned perspective view of an embodiment of a hybrid connector with lever;

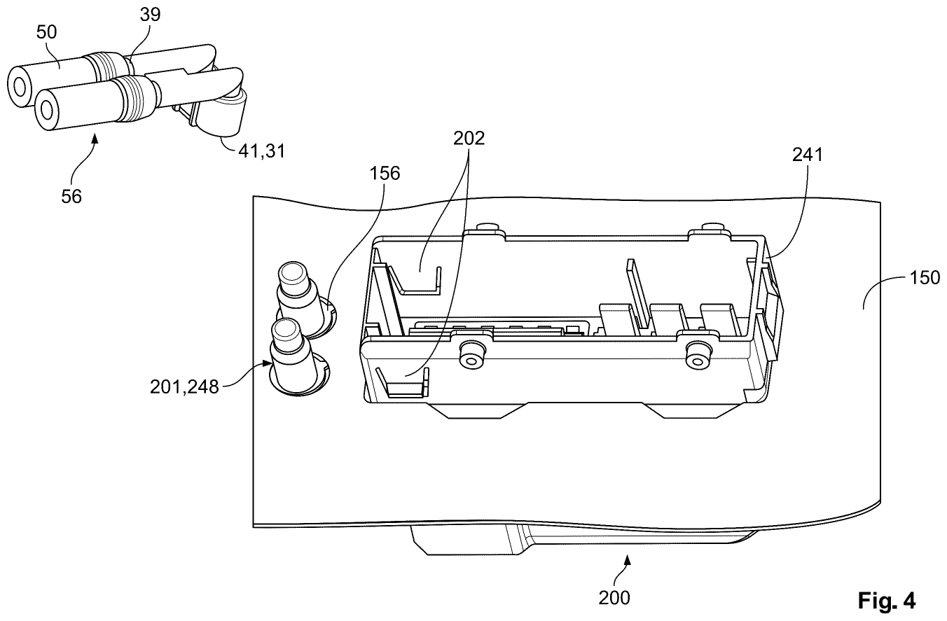

FIG. 4 a schematic perspective view of the mating connector in an embodiment with two fluid channels; and

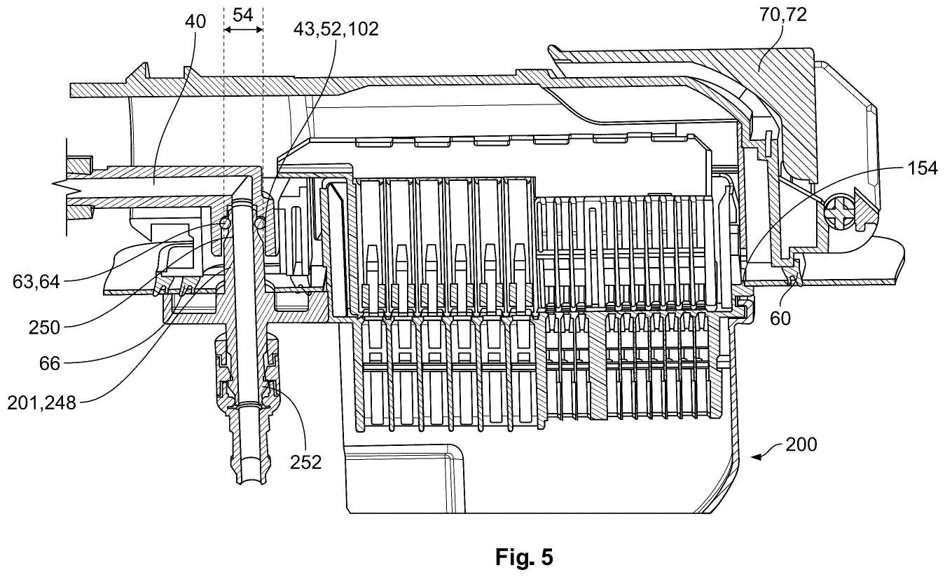

FIG. 5 a schematic sectional perspective view of a hybrid connector.

The Figures show an embodiment of a hybrid connector 100. The hybrid connector 100 is connected to a matching mating connector 200, in this case plugged together. The mating connector 200 can, for example, be attached to a sheet metal 150 of a door 300 of a vehicle. There may be a hole in the sheet metal 150 through which parts of the mating connector 200 or the hybrid connector 100 protrude.

The hybrid connector 100 is not only used for the transmission of electrical power or electrical signals by means of current and/or voltage, but also for supplying a wiper system with cleaning water and/or air. Such wiper systems for mirrors or cameras may be required for autonomous driving, for example.

In particular, the hybrid connector 100 comprises a housing part 20, which is typically injection-molded from a plastic.

The housing part 20 comprises an electrical connection area 21, on which contact elements not shown in more detail are provided for contacting corresponding mating elements on the mating connector 200. The contact elements are attached to cables not shown in more detail. The electrical connection can be used, for example, to transmit electrical power and/or signals for the wiper system and/or the camera.

In addition to the electrical connection area 21, the housing part 20 has a fluid connection area 24, which is configured for the transmission of at least one fluid. In the example shown, at least one fluid is a liquid, namely cleaning water for the wiper system. In other applications, at least one fluid can also be another liquid or a gas.

The fluid connection area 24 is separated from the electrical connection area 21 in order to prevent escaping fluid from causing a short circuit between the contact elements or damaging the contact elements, for example through corrosion.

A contact field 23 formed by the contact elements is surrounded by a collar 25. A seal 60 is attached to the collar 25, which surrounds the electrical connection area 21 in a first section 61 and the fluid connection area 24 in a second section 62. Due to the one-piece configuration of the seal 60, the manufacturing effort is minimized.

The housing part 20 is configured such that when the hybrid connector 100 is connected to the mating connector 200 along a connection direction V, an electrical connection and at least one fluid connection, in particular one or more fluid connections, are established simultaneously.

The hybrid connector 100 is configured as a plug 101 in which the plug-in direction S corresponds to the connection direction V. The hybrid connector 100 and the mating connector 200 each have elements that are matched to each other for this purpose. For example, the contact elements 102 on the hybrid connector 100 can be configured as plug elements and the contact elements 201 on the mating connector 200 can be configured as sockets.

Accordingly, an end section 43 of at least one fluid channel 40 on the hybrid connector 100 is configured as a plug element 47, which is inserted into a socket 247 of at least one fluid channel 240 on the mating connector 200. For precise positioning, the end section 43 forms an inner funnel 42 which cooperates with a circumferential, externally cone-shaped collar 242 on the socket 247. A separate seal 63 is provided for sealing between the plug element 47 and the socket 247. The fluid connection area 24 is thus shielded from the electrical connection area 21 by two separate seals 60, 63.

In a further preferred embodiment, the seal 63 is configured as an O-ring 64 and is attached between the end section 43 of at least one fluid channel 40 and the opposing contact element 201. In this case, the contact element 201 is configured as a plug element 248 with an inner funnel 250 that tapers in the direction opposite to the plug-in direction S. In this configuration, the end section 43 is configured as a socket 52, which surrounds the plug element 248 and has a larger diameter 54 than the plug element 248. Between the collar 25 and the sheet metal 150, the hybrid connector 100 has a seal 66, which surrounds the respective end section 43 of the at least one fluid channel 40, preferably of the one or two fluid channels 40, and seals the at least one fluid channel 40 with respect to the electrical connection area 21.

The at least one fluid channel 40 has an internal connection 41 at a proximal end 31, which serves to connect to the corresponding elements 201 on the mating connector 200. Furthermore, the at least one fluid channel 40 has an external connection 49 at a distal end 39. There, the at least one fluid channel 40 is connected to a fluid hose 50 in each case. Typically, one end of the at least one fluid hose 50 is slid over the external connection 49 and held by projections.

In a preferred embodiment, the mating connector 200 has coupling elements 252 in the plug-in direction S below the sheet metal 150, which protrude radially from the at least one fluid channel 240 of the mating connector 200. The coupling elements 252 are configured such that they can be engaged with a coupling 254 in order to enable a straight outlet in the plug-in direction S of the at least one fluid and/or in order to connect further fluid channels.

The external connection 49 of the at least one fluid channel 40 is configured such that the at least one fluid hose 50 is connected transversely to the connection direction V. This results in the at least one fluid hose 50 forming an arc in its further course, which enables the plug 100 to move along the connection direction V (see, for example, FIG. 2, which shows the attached and thus the intended operating state).

In the example shown, an attachment direction A of the at least one fluid hose 50 is perpendicular to the connection direction V and parallel to a first transverse direction Q1. In other configurations, an angle deviating from 90° may also be possible. Furthermore, the attachment direction A may also have components in a second transverse direction Q2, which is perpendicular to the first transverse direction Q1 and perpendicular to the connection direction V.

In order to be able to easily demold the housing part 20 during injection molding, the at least one fluid channel 40 comprises two segments 44, 46, each of which has a cylindrical inner clear cross-section. In this context, the first segment 44 is connected to the second segment 46 via a 90° corner 45. In other configurations, however, the inner cross-sections can also change, in particular increase in size towards the outside, for example to enable easier demolding. Furthermore, the two segments 44, 46 can have different cross-sectional areas if, for example, the pressure in the respective fluid is to be increased or reduced.

In the embodiment shown, the at least one fluid channel 40 is in one piece with the rest of the housing part 20. In particular, if the at least one fluid channel 40 is difficult to form, for example because it has a curved shape, or if it is to be made of a different material, it can also be manufactured as a separate part and later connected to the rest of the housing part 20. In a preferred configuration, for example, two fluid channels 40 can be manufactured and assembled as a separate part 56. In this case, the fluid channels 40 of the separate part 56 can be connected to each other in one piece at the proximal end 31 via a material bridge 57. Furthermore, in this configuration, the proximal end 31 has flexible latching elements 58, for example latching arms 59, which extend upwards at an angle from the proximal end 31 in the opposite direction of the plug-in direction S and radially away from the outer circumference of the respective fluid channel 40. When the proximal end 31 of the separate part 56 is plugged in in the plug-in direction S, the latching elements 58 are locked on the projection 26 of the collar 25 so that the separate part 56 is prevented from coming loose in the direction opposite to the plug-in direction S.

The housing part 20 further comprises a grommet attachment portion 29 to which a grommet 90 can be attached. The grommet 90 can be understood to be a hose- or tube-shaped element made of a flexible material, which serves to protect the electrical cables and the at least one fluid hose 50. The grommet attachment portion 29 is configured to attach the grommet 90 so that, at its end, it extends along the attachment direction A of the at least one fluid hose 50. The grommet 90 can have at least one bellows 91, which enables a slight bending deformation.

The housing part 20 is configured such that, when it is attached, the fluid connection area 24 lies completely below the electrical connection area 21. This is achieved by the fact that the fluid connection area 24, in particular the internal connection 41, lies completely in a first half-space H1 and the electrical connection area 21 with the contact elements lies completely in a second half-space H2. The two complementary half-spaces H1, H2 are defined by a plane E and cut off from each other. This prevents the at least one fluid from penetrating into the electrical connection area 21 during connection or disconnection, as it follows the force of gravity and can only drip into the first half-space H1.

In order to apply a contact force, the hybrid connector 100 also has a slide 70, which is displaceable along the first transverse direction Q1 relative to the housing part 20 and thereby, for example, achieves a securing of the hybrid connector 100 to the mating connector 200 or applies a contact force.

In other configurations, other securing mechanisms may also be provided, for example a mechanism with a lever 72 (as can be seen in FIG. 3). In this configuration, the lever 72 is formed complementarily to the housing part 20 and has a hinge 74 with which the lever 72 can be moved towards the housing part 20 about the second transverse direction Q2 and secures the hybrid connector 100 with a securing element 76 by the lever 72 pushing the securing element 76 into the housing part 20 in the direction of the first transverse direction Q1.

The hybrid connector 100 is configured to be connected to the mating connector 200 attached to the sheet metal 150. The sheet metal 150, in particular its surface 151, provides a flat surface 152 to which the hybrid connector 100 is attached. In this context, the surface 151 of the metal sheet 150 runs parallel to the first transverse direction Q1 and the second transverse direction Q2. In order to be connected to this in a well-sealing manner, an outer area of the seal 60 and the seal 66 lies in a plane that is perpendicular to the plane E that separates the two half-spaces H1, H2. The attachment direction A is parallel to the plane formed by the surface 151.

In a preferred configuration, the mating connector 200 can have latching elements 202 in order to fix it to the sheet metal 150, which protrude from the mating connector 200 in the transverse direction Q2 and can be flexibly deflected in order to enable latching with the sheet metal 150 after plugging the mating connector 200 into the opening 154. The sheet metal 150 can furthermore have openings 156 in order to receive the corresponding contact elements 201 of the mating connector 200.

### REFERENCE SIGNS

20 housing part
21 electrical connection area
23 contact field
24 fluid connection area
25 collar
26 projection
29 grommet attachment portion
31 proximal end
39 distal end
40 fluid channel
41 internal connection
42 funnel
43 end section
44 first segment
45 corner
46 second segment
47 plug element
49 external connection
50 fluid hose
52 socket
54 diameter of the socket
56 separate part
57 material bridge
58 latching element
59 latching arm
60 seal
61 section seal
62 section seal
63 seal
64 O-ring
66 seal
70 slide
72 lever
74 hinge
76 securing element
90 grommet
91 bellows
100 hybrid connector
101 plug
102 contact element
150 sheet metal
151 surface
152 surface
154 opening
156 opening
200 mating connector
201 contact element
202 latching element
240 fluid channel
241 internal connection
242 collar
247 socket
248 plug element
250 funnel
252 coupling element
254 coupling
300 door
A attachment direction
E plane
H1 first half-space
H2 second half-space
Q1 first transverse direction
Q2 second transverse direction
S plug-in direction
V connection direction

1. A housing part for a hybrid connector for the transmission of electrical current and at least one fluid to a mating connector along a connection direction, comprising an electrical connection area and a fluid connection area which is separate from the electrical connection area and has an external connection located at a distal end with at least one fluid channel for connecting at least one fluid hose transversely to the connection direction.

2. The housing part according to claim 1, wherein in the connected state the electrical connection area is sealed in a fluid-tight manner.

3. The housing part according to claim 1, wherein a collar surrounds a contact field of the hybrid connector.

4. The housing part according to claim 1, wherein the at least one fluid channel comprises two respective segments with cylindrical inner shapes.

5. The housing part according to claim 1, wherein the at least one fluid channel is configured as a separate part mounted to the hybrid connector.

6. The housing part according to claim 1, wherein an internal connection of the at least one fluid channel located at a proximal end is configured for connection parallel to the connection direction.

7. The housing part according to claim 6, wherein the internal connection has a separate seal.

8. The housing part according to claim 1, wherein the inner clear cross-section of the at least one fluid channel widens in an end section towards one or the proximal end.

9. The housing part according to claim 1, wherein the housing part comprises a grommet attachment portion for attaching a grommet.

10. The housing part according to claim 1, wherein the housing part is configured such that, in the intended operating state, the fluid connection area is completely below the electrical connection area with respect to gravity.

11. The housing part according to claim 1, wherein the fluid connection area lies completely in a first half-space defined by a plane and the electrical connection area lies completely in a second half-space complementary to the first half-space.

12. A hybrid connector, comprising a housing part according to claim 1.

13. The hybrid connector according to claim 12, wherein the hybrid connector is configured as a plug.

14. The hybrid connector according to claim 12 wherein the hybrid connector is configured such that the connection of the internal connection to a mating element is sealed off from the electrical connection area in the connected state by at least two independent seals.

15. The hybrid connector according to claim 12, wherein the hybrid connector is configured to be connected to a mating connector attached to a surface.
